(19) United States
(12) Patent Application Publication
(10) Pub. No.: US 2023/0091351 A1
(43) Pub. Date: Mar. 23, 2023

(54) CHAIN TENSIONER DEVICE

(71) Applicant: Stark Future, S.L., Sitges (ES)

(72) Inventors: Anton Wass, Sitges (ES); Paul Soucy, Sitges (ES)

(73) Assignee: Stark Future, S.L., Sitges (ES)

(21) Appl. No.: 17/898,698

(22) Filed: Aug. 30, 2022

(30) Foreign Application Priority Data
Sep. 22, 2021 (ES) U202131879

(51) Int. Cl. B62M 9/16; B62M 9/126

(52) U.S. Cl. CPC B62M 9/16; B62M 9/126

(57) ABSTRACT

A chain tensioner device includes: a threaded bolt (3) for adjusting tension on a chain, that remains inserted in a part (4) integral with the wheel shaft (5), arranged in horizontal position, so that the tip (3a) of the bolt (3), presses on a second part (6) integral at the opposite end of the gear, so that tightening or loosening the bolt (3) determines a gap between both parts (4, 6) to regulate the tension and a discretization mechanism of the gap between the first part (4) and the second part (6) that includes at least a retractable element (8) either in the bolt (3) or in the first part (4) that contacts and is fitted in one of the series of slots (11) provided either in the bolt (3) or in the first part (4) so that it is possible to know the tightening or loosening of the bolt (3) applicable in each action.

### OBJECT OF THE INVENTION

The invention, as stated in the title of this specification, refers to a chain tensioner device contributing, to the function to which it is designed, with advantages and characteristics that are disclosed in detail thereafter and that means an improvement of the current state-of-the art.

The object of this invention falls on a device that, applicable to the rear wheel of the motorcycles, bicycles and similar vehicles with chain gear, has the aim to allow regulating the chain tension providing the advantage of facilitating the said operation against the currently known systems for the same aim.

### FIELD OF APPLICATION OF THE INVENTION

The field of application of this invention is within the automotive sector, in particular focusing in the industry engaged in manufacturing accessories for motorcycles, bicycles and similar vehicles with chain gear and more concretely in the field of chain tension regulating systems.

### BACKGROUND OF THE INVENTION

As it is known, in the motorcycles and other similar vehicles with chain gear, it is very important to correctly regulate the chain tension, for which it is necessary to correct the position of the rear wheel shaft.

Currently, to carry out the said regulation, on both sides of the rear wheel shaft, there are two screws provided with nuts and safety nut that have to be loosened to be able to move the wheel and tightened again according to the required regulation, having to watch visual marks provided between the frame and the wheel and, normally, the suitable position of which is stated by the manufacturer.

The problem is that this operation, in addition to be complicated, requires using two tools, one to hold the safety nut and another to rotate the nut, therefore the handling is difficult.

In addition, another significant drawback is that the guideways to achieve that the alignment of the shaft is correct and regulate the movement on both sides of the wheel are not very accurate because it is dealt with visual marks and it is required to guess in order that they are identical on both sides of the wheel, so that, if the individual who carries out the operation is an amateur instead of a trained operator, maybe he does not achieve a correct alignment of the shaft and, consequently, that means a risk when driving the vehicle.

It would be expected, therefore, to count on a simpler system allowing to avoid the said drawbacks to correctly regulate the chain tension assuring a correct alignment of the shaft and allowing that the user himself, without having to have recourse to specialized workshops, can carry out the said operation, the objective of this invention being to develop a tensioner device with the said premises.

On the other hand, and as reference of the current state-of-the-art, it shall be pointed out that, at least the applicant is not aware of the existence of any other chain tensioner device presenting technical and structural characteristics same or similar to those herein claimed.

### EXPLANATION OF THE INVENTION

The chain tensioner device that the invention proposes is configurated as the suitable solution to the above stated objective, the characterizing details making it possible and that distinguish it conveniently appearing in the final claims attached to this description.

Concretely, what the invention proposes, it was stated before, is a device that, applicable on both sides of the rear wheel of a motorcycle, bicycle or other similar vehicle with chain gear, has the aim to allow regulating the chain tension by means of the wheel shaft positioning with respect to the opposite area of the gear, which presents the advantage to count on such a configuration that facilitates the said operation against the currently known systems for the same purpose.

For this and more specifically, the tensioner device of the invention comprises, essentially:
a threaded bolt for adjusting the chain, that remains inserted in a part integral with the wheel shaft, arranged in horizontal position, so that tightening or loosening the said bolt determines the push or not of the integral part to the opposite end of the gear on which it contacts by the tip, and
a discretization mechanism of the gap between the first part (4) and the second part (6) comprises at least a retractable element (8) either in the bolt (3) or in the first part (4) that contacts and is fitted in one of a series of slots (11) provided either in the bolt (3) or in the first part (4) so that it is possible to know the tightening or loosening of the bolt (3) applied in each action in order to repeat it in an identical manner on each side of the wheel.

In addition, in the preferred embodiment of the invention, the bolt is a headless bolt that remains completely inserted in the part integral with the wheel shaft, being provided at its base, that means, at the opposite end of the pushing tip, of a machined recess for inserting the screwing tool, for example a Torx tool, that is for a type of screw head characterized in that it is six-point star-shaped or an hex or allen type tool, the said recess remaining accessible from the rear part of the shaft, though a hole pierced in the said part to that effect.

With all this, the device provides the advantage that the device can be activated from the rear part using only one tool instead of two, as it occurs with the preceding nut and safety nut system. In addition, it offers full liberty to rotate the tool 360 degrees or more, without changing the position of the tool.

Another advantage is that the user can easily make coincident the position on each side, because each full turn of the bolt presents a given number of clicks, that is created by means of the slot on the chain adjustment bolt and the ball of the spring mechanism that makes a click in the said slot.

Last, another advantage is that only one tool has to be used and not two, because there is no longer a safety nut, because the spring ball mechanism keeps the bolt in its place.

### DESCRIPTION OF THE DRAWINGS

To complement the description being carried out and in order to assist to best understanding the characteristics of the invention, attached to this specification, as an integral part thereof, there is set of drawings in which, for illustration and no limitation purpose, the following has been represented:

FIG. 1.—It shows a side elevation view of an example of rear wheel of a motorcycle with chain gear in which an example of the chain tensioner device of the invention has been incorporated, the general arrangement of the device on one of the sides of the wheel can be seen in a sectional portion of the said area;

FIG. 2—It shows an enlarged view of the detail A appearing in the FIG. 1 and that shows the sectional portion of the area of the wheel in which the device object of the invention is incorporated, the parts and elements it comprises can be seen as well as their configuration and arrangement; and

FIG. 3.—It shows an enlarged view of the retractable ball mechanism and the bolt that comprises the device of the invention their configuration being seen with more details.

### PREFERRED EMBODIMENT OF THE INVENTION

Seen the said figures, and according to the numerals adopted, a non-limiting example of embodiment of the chain tensioner device of the invention can be seen, which comprises what is described in detail below.

Thus, as it can seen in the said figures, the tensioner device (1) of the invention, applicable to be dually incorporated on both sides of the rear wheel (2) of the motorcycle or vehicle on which it is installed, essentially comprises:
a threaded bolt (3) for adjusting the chain, that remains inserted in a part (4) integral with the wheel shaft (5), arranged in horizontal position, so that the tip (3a) of the said bolt (3), that is preferable flat, presses on a second part (6) integral at the opposite end of the gear, so that tightening or loosening the bolt (3) determines the gap between both parts (4, 6) to regulate the chain tension (not shown), and
a discretization mechanism of the gap between the first part (4) and the second part (6) comprises at least a retractable element (8) either in the bolt (3) or in the first part (4) that contacts and is fitted in one of the series of slots (11) provided either in the bolt (3) or in the first part (4) so that it is possible to know the tightening or loosening of the bolt (3) applicable in each action.

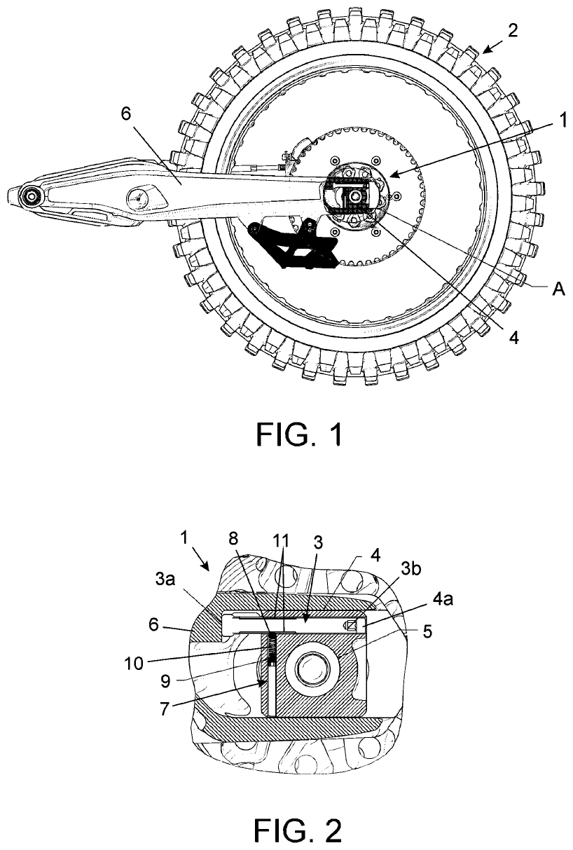

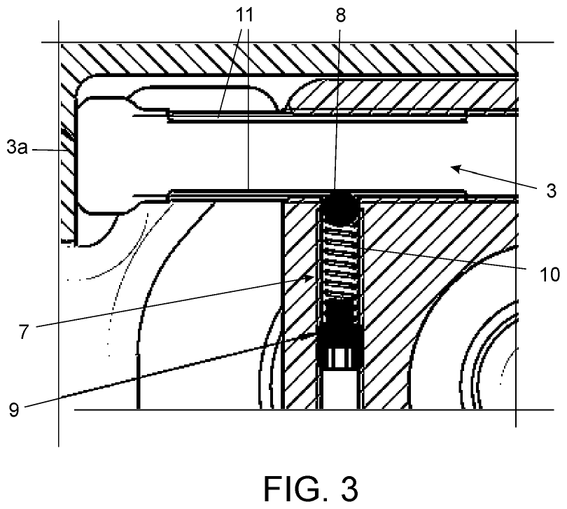

In a first preferred embodiment, as it is shown in the FIGS. 1-3, the discretization mechanism of the gap between the first part (4) and the second part (6) comprises in the first part (4), a retractable ball (8) inserted in the end of a plunger (9) with an internal spring (10) that tends to push the said ball (8) outwards the plunger (9); and
in the bolt (3) one of the series of slots (11) in which the ball contacts (8) and is fitted.

In a second preferred embodiment, the discretization mechanism of the gap between the first part (4) and the second part (6) comprises
in the bolt (3), two retractable balls (8) inserted in the ends of a plunger (9) with an internal spring (10) that tends to push the said balls (8) outwards the plunger (9), and
in the first part (4) one of the series of slots (11) in which the balls (8) contact and are fitted.

In this manner, the said discretization mechanism of the gap between the first part (4) and the second part (6), in addition to keep the bolt (3) in its place, provokes a noise of “click” each time the bolt (3) rotates and the ball (8) passes from one slot (11) to another, when it is screwed or unscrewed through a tool inserted at its base (3b), allowing that the user controls the number of “clicks” to repeat it in an identical manner on each side of the wheel (2).

Preferably, the bolt (3) is a headless bolt that remains completely inserted in the part (4) integral with the wheel shaft (5), being provided at its base (3b) with a machined recess for inserting the tool, for example a Torx or hex tool, and that is accessible from the rear part of the shaft (5), though a hole (4a) pierced in the said part (4).

Sufficiently disclosed the nature of this invention, as well as the manner of implementing it, it is not deemed necessary to extend anymore its explanation in order that any person skilled in the art understands its extends and the advantages arising from it.

1. A chain tensioner device that, applicable to be dually incorporated on both sides of the rear wheel (2) of the motorcycle or vehicle on which it is installed, comprises:
a threaded bolt (3) for adjusting tension on a chain, that remains inserted in a part (4) integral with a wheel shaft (5), arranged in horizontal position, so that the tip (3a) of the threaded bolt (3) presses on a second part (6) integral at the opposite end of a gear, so that tightening or loosening the threaded bolt (3) determines a gap between both parts (4, 6) to regulate the tension of the chain, and
a discretization mechanism of the gap between the first part (4) and the second part (6) comprises at least a retractable element (8) either in the threaded bolt (3) or in the first part (4) that contacts and is fitted in one of the series of slots (11) provided either in the threaded bolt (3) or in the first part (4) so that it is possible to know the tightening or loosening of the threaded bolt (3) applicable in each action.

2. The chain tensioner device, according to the claim 1, characterized in that the discretization mechanism of the gap between the first part (4) and the second part (6) comprises:
in the first part (4), a retractable ball (8) inserted in the end of a plunger (9) with an internal spring (10) that tends to push the retractable ball (8) outwards the plunger (9); and
in the threaded bolt (3) one of the series of slots (11) in which the retractable ball (8) contacts and is fitted.

3. The chain tensioner device, according to the claim 1, characterized in that the discretization mechanism of the gap between the first part (4) and the second part (6) comprises:
in the threaded bolt (3), two retractable balls (8) inserted in the ends of a plunger (9) with an internal spring (10) that tends to push the said balls (8) outwards the plunger (9), and
in the first part (4) one of the series of slots (11) in which the two retractable balls (8) contact and are fitted.

4. The chain tensioner device, according to claim 1, characterized in that the threaded bolt (3) is a headless bolt and provided at its base (3b) with a machined recess for inserting a tool.

5. The chain tensioner device, according to claim 1, characterized in that the threaded bolt (3) remains fully inserted in the part (4) integral with the wheel shaft (5) and a wheel shaft base (3b) is accessible from a rear part of the wheel shaft (5), though a hole (4a) pierced in the part (4).

6. The chain tensioner device, according to claim 1, characterized in that the tip (3a) of the threaded bolt (3) is flat.

7. The chain tensioner device, according to claim 4, wherein the tool is a Torx tool.

8. The chain tensioner device, according to claim 4, wherein the tool is a hex tool.
